(19) United States
(12) Patent Application Publication
(10) Pub. No.: US 2016/0286758 A1
(43) Pub. Date: Oct. 6, 2016

(54) DOG JACKET INCLUDING TEMPERATURE REGULATING MATERIAL AND MANUFACTURE THEREOF

(71) Applicant: Elizabeth Nolan, Aiken, SC (US)

(72) Inventor: Elizabeth Nolan, Aiken, SC (US)

(21) Appl. No.: 15/088,756

(22) Filed: Apr. 1, 2016

Related U.S. Application Data
(60) Provisional application No. 62/141,928, filed on Apr. 2, 2015.

(51) Int. Cl. A01K 13/00

(52) U.S. Cl. CPC A01K 13/006

(57) ABSTRACT

A thermal regulating dog jacket is described that can be of particular benefit when utilized in warmer temperatures (indoors or outdoors). The dog jackets incorporate a temperature regulating material that can absorb thermal energy in warm weather as well as release thermal energy in cold weather. The dog jacket can provide thermal regulation without requiring an external triggering mechanism, such as additional moisture or sunlight.

### CROSS REFERENCE TO RELATED APPLICATION

This Application claims filing benefit of United States Provisional Patent Application Ser. No. 62/141,928 entitled “Thermally Regulated Dog Coat Using Phase Change Material and Manufacturing Thereof,” having a filing date of Apr. 2, 2015, which is incorporated herein by reference for all purposes.

### BACKGROUND

Providing protection and safety for dogs on warm days to reduce hyperthermia is important for health of the animal. Dogs' normal temperatures can range between about 101°-103° F. (38°-39° C.). Canine body temperatures above 103° F. are considered abnormal and temperature maintained at 105°-106° F. (40.5°-41° C.) for a prolonged period can be fatal. Heat stroke, a non-fever hyperthermia, occurs when the dog's internal heat-dispensing mechanisms cannot accommodate the excessive heat leading to multiple organ dysfunctions.

To prevent the hyperthermia, cooling jackets soaked in cool water have been developed for placement on the dog. These jackets utilize a humidity buildup between the dog's skin and the jacket to ‘wick’ the heat away from the dog's body. Unfortunately, these jackets must be re-wet continually since dogs do not sweat on their bodies.

Many products claim to regulate temperature, but in reality, they merely manage moisture created at the skin surface, and this moisture is not formed until long after the body temperature has increased. By the time such products start working, the wearer has already experienced discomfort from overheating.

What is needed in the art is a jacket that can regulate excessive body temperature of a dog. In particular, a device that can prevent overheating in a dog such as may lead to hyperthermia would be of great benefit.

### SUMMARY

According to one embodiment, disclosed is a thermally regulated dog jacket that includes a body portion, a first chest flange, a second chest flange, and a belly band. In addition, the body portion can include a temperature regulating material. The first and second chest flanges can extend from a collar line of the body portion and can be configured to be removably attached to one another, e.g., via a hook-and-loop type fastener. The belly band can extend from a first side of the body portion and can be configured to be removably attachable to an opposite second side of the body portion.

Also disclosed are methods for forming a thermally regulated dog jacket. For instance, a method can include shaping a textile to form a body portion of the dog jacket. More specifically, the textile can include a temperature regulating material. The method can also include forming the first and second chest flanges as extensions of the body portions or, alternatively, attaching a first and second chest flange to the body portion. The method can likewise include attaching the belly band to the body portion.

In one embodiment, the body portion can be a multi-layer structure, and the temperature regulating material can be a component of a layer, e.g., an inner layer of the body portion. For instance, an inner layer of the body portion can include a non-woven fibrous web, and the temperature regulating material can be a component of the non-woven web. The multi-layer body portion can include one or more outer layers, e.g., a lightweight textile that can protect the temperature regulating material and/or can be utilized for decorative purposes.

### BRIEF DESCRIPTION OF THE DRAWINGS

The present disclosure may be better understood with reference to the accompanying figures, in which:

FIG. 1 illustrates one embodiment of a multi-layer construct as may be utilized in forming a body portion of a dog jacket.

FIG. 2 illustrates another embodiment of a multi-layer construct as may be utilized in forming a body portion of a dog jacket.

FIG. 3 illustrates one embodiment of a dog jacket.

FIG. 4 illustrates another embodiment of a dog jacket.

FIG. 5 illustrates another embodiment of a dog jacket.

FIG. 6 illustrates one embodiment of an extension band.

Repeat use of reference characters in the present specification and drawings is intended to represent the same or analogous features or elements.

### DETAILED DESCRIPTION

Those of ordinary skill in the art may practice the subject matter described in the following description as well as modifications and variations to the present subject matter without departing from the spirit and scope of the present disclosure. In addition, it should be understood that aspects of the various embodiments may be interchanged in whole or in part. Furthermore, those of ordinary skill in the art will appreciate that the foregoing description is by way of example only, and is not intended to limit the disclosure.

In general, the present disclosure is directed to a thermal regulating dog jacket. More specifically, dog jackets as disclosed herein can provide a safe and protective comfortable covering for dogs that can be of particular benefit when utilized in warmer temperatures (indoors or outdoors).

More specifically, disclosed dog jackets can incorporate a temperature regulating material that can aid in maintaining the body temperature of a dog that is wearing the jacket. The use of temperature regulating materials can allow the dog jacket to provide “multi-directional” or “dynamic” thermal regulation rather than “unidirectional” or “static” thermal regulation. In particular, the temperature regulating material of the dog jacket can absorb energy in warm weather as well as release energy in cold weather. In such manner, the dog jacket can provide cooling in warm weather and heating in cold weather, thus maintaining a desired level of comfort under different weather conditions. Moreover, in accordance with “dynamic” thermal regulation, the thermal regulating property of the dog jacket can vary under changing environmental conditions. Beneficially, the dog jacket can provide thermal regulation without requiring an external triggering mechanism, such as additional moisture or sunlight.

As utilized herein, the term “temperature regulating material” can generally refer to a material that can absorb or release an amount of energy (i.e., the latent heat of the material) at a constant (or substantially constant) temperature. As such, a temperature regulating material can absorb energy from (or release energy to) a source within a stable temperature range and thereby cool (or heat) the source. In those embodiments in which the temperature regulating material changes phase within the temperature range, the temperature range can encompass the phase transition temperature. A temperature regulating material can maintain a constant temperature during that period at which the phase change material is absorbing or releasing heat, typically as the phase change material undergoes a transition between two states (e.g., liquid and solid states, liquid and gaseous states, solid and gaseous states, or two solid states). This action is typically transient, and can occur until a latent heat of the temperature regulating material is absorbed or released during the phase change.

As used herein, the term “latent heat” can generally refer to an amount of energy absorbed or released by a material at relatively constant temperature, e.g., during a phase change.

By use of a temperature regulating material in formation of a dog jacket, the body temperature of a dog can be regulated. For instance in a warm environment, as the body temperature of the dog rises above the transition temperature of the temperature regulating material in the dog jacket that is worn by the dog, the thermal energy radiating from the dog's body can be absorbed by the temperature regulating material. This energy can be absorbed by the material in an isothermal fashion, such that the temperature of the jacket does not continue to increase, but rather remains at or near the transition temperature and can function as a heat “sink” for the dog, providing a cooling effect for the dog by absorbing energy radiated from the dog's body. Similarly, in a colder environment, as the temperature of the dog's body drops below the transition temperature, the temperature regulating material can release energy as the material transitions isothermally from one phase to another and the released energy can serve to warm the dog's body.

Temperature regulating materials as are known in the art can be incorporated in a dog jacket. By way of example and without limitation, temperature regulating materials as disclosed in U.S. Pat. No. 7,666,500 to Magill, et al., which is incorporated herein by reference for all purposes, may be utilized.

A temperature regulating material as encompassed herein can include a variety of organic and inorganic substances. Examples of temperature regulating materials include, by way of example and not by limitation, hydrocarbons, hydrated salts, waxes, oils, water, fatty acids, fatty acid esters, etc. According to some embodiments, a polymeric material can be desirable as a result of having a relatively high molecular weight, a larger molecular size, or a higher viscosity relative to non-polymeric phase change materials, which can provide for improved processing in formation of fibers incorporating the temperature regulating material. For example, polyethylene glycols can be used as a temperature regulating material in some embodiments such as, for instance, polyethylene glycols that are endcapped with fatty acids. Polyesters having a melting point in the range of about 0° C. to about 40° C. can be utilized in some embodiments. According to some embodiments, paraffinic hydrocarbons having from 10 to 44 carbon atoms can be utilized as temperature regulating materials.

A temperature regulating material can have a transition temperature ranging from about from about 22° C. to about 40°, from about 30° C. to about 35° C., or from about 31° C. to about 34° C. in some embodiments. The temperature regulating material can have a latent heat that is at about 40 J/g or greater, or about 50 J/g or greater in some embodiments. By way of example, a temperature regulating material can have a latent heat ranging from about 40 J/g to about 400 J/g in some embodiments.

According to one embodiment, the temperature regulating material can be incorporated in fibers that may be utilized in forming a dog jacket. For instance, and depending upon the characteristics of the temperature regulating material, the fibers can be formed exclusively of the temperature regulating material. In other embodiments, the fibers can be composite fibers and can incorporate a temperature regulating material as a component of the multi-component fibers.

A temperature regulating material can be a solid/solid phase change material. A solid/solid phase change material is a type of phase change material that typically undergoes a transition between two solid states (e.g., a crystalline or mesocrystalline phase transformation) and hence typically does not become a liquid during use. According to such an embodiment, a temperature regulating material in a raw form (e.g., the phase change material is non-encapsulated, i.e., not micro- or macroencapsulated) can be provided as a solid and fibers for use in forming a dog jacket can be formed of the temperature regulating material, optionally blended with other materials as is known in the art.

According to other embodiments, a fiber can include a temperature regulating material that is encapsulated in, surrounded by, absorbed to, or reacted with a secondary material and this composite material can be utilized in formation of fibers for use in a dog jacket. The containment structure can facilitate handling of the temperature regulating material while offering a degree of protection to the material during manufacture of a fiber and a dog jacket made therefrom. Moreover, a containment structure can serve to reduce or prevent leakage of the phase change temperature regulating material from the fiber during use.

In one embodiment, a fiber can include a temperature regulating material in the form of microcapsules that contain a phase change material. The microcapsules can be uniformly or non-uniformly dispersed within a fiber. Microcapsules can be formed as shells enclosing the phase change material and can include individual microcapsules formed in a variety regular or irregular shapes (e.g., spherical, ellipsoidal, and so forth) and sizes. Examples of a containment structure include, without limitation, silica particles, zeolite particles, carbon particles, and absorbent materials (e.g., cellulosic materials, poly(meth)acrylate materials, etc.). For example, a temperature regulating material can include silica particles, zeolite particles, carbon particles, or an absorbent material impregnated with a phase change material.

One or more polymeric materials, at least one of which including the temperature regulating material, can be utilized in forming fibers of the dog jacket. In general, a polymeric material for use in forming the fibers of a dog jacket can include any polymer (or mixture of polymers) that has the capability of being formed into a fiber. For example, in those embodiments in which a melt spinning process is used to form a fiber, a polymeric material can include a thermoplastic polymer (or a mixture of thermoplastic polymers). According to other embodiments of the invention, a polymeric material can include an elastomeric polymer (or a mixture of elastomeric polymers). Examples of polymers that can be used in forming a composite fiber can include, without limitation, polyamides (e.g., nylons, etc.), polyesters (e.g., polyethylene terephthalate, polylactide, etc.), polyethers (e.g., polyethylene glycol), natural polymers (e.g., cellulosics, chitosans, etc.), polyolefins (e.g., polyethylene, polypropylene, polybutylene, etc.), and copolymers.

A multi-component fiber can include the temperature regulating material and one or more additional materials arranged in any of a variety of configurations. For example, a fiber can include components in an island-in-sea configuration or a core-sheath configuration. Components can be arranged in other configurations, such as, by way of example and not by limitation, a matrix or checkerboard configuration, a segmented-pie configuration, a side-by-side configuration, a striped configuration, and so forth. Moreover, a multi-component fiber can include polymeric component(s) as well as non-polymeric component(s). By way of example, in some embodiments a non-polymeric temperature regulating material can be dispersed within a polymeric component in the fibers.

A fiber including a temperature regulating material as at least one component of the fiber can include virtually any percentage by weight of the temperature regulating material to provide desired thermal regulating and mechanical properties. For instance, a fiber can include up to about 100 percent by weight of a temperature regulating material. When considering a multi-component fiber, a fiber can include about 90% by weight or more, about 50% by weight or more, about 25% by weight, about 10% by weight or more, or about 5% or weight or more of the temperature regulating material.

A multi-component fiber can have a latent heat that about 2 J/g or greater, such as, for example, about 5 J/g or greater, or about 14 J/g or greater in some embodiments.

Fibers incorporating the temperature regulating material can be formed according to any suitable fiber formation process. For example, in a solution spinning process, one or more polymeric materials and one or more temperature regulating materials forming multi-component fibers can be dissolved in a solvent prior to passing through orifices of a spinneret. In a wet spinning process, the spinneret can be submerged in a chemical bath such that, upon exiting the spinneret, materials can precipitate from solution and form a solid fiber. In a dry spinning process, materials can emerge from the spinneret in air and solidify due to the solvent (e.g., acetone) evaporating in air.

In a melt spinning process, one or more polymeric materials and/or one or more temperature regulating materials can be delivered to orifices of a spinneret in a molten state. In some embodiments, prior to passing through the orifices, a temperature regulating material can be mixed with a first polymeric material to form a blend. As a result of mixing, the temperature regulating material can be dispersed within and at least partially enclosed by the first polymeric material. The polymeric material(s) can then be directed through each orifice to form the fibers according to standard practice.

Once formed, the fibers including a temperature regulating material can be further processed according to methods as are known in the art including, without limitation, woven, non-woven, knitting, or weaving processes to form various types of plaited, braided, twisted, felted, knitted, woven, or non-woven textiles as may be utilized in forming a dog jacket. For example, multi-component fibers can be randomly laid on a forming surface to form a continuous, non-woven web of fibers. According to one embodiment, multi-component fibers can be cut into short staple fibers prior to forming the web. The web can then be bonded using any conventional bonding method to form a stable, non-woven fabric for use in manufacturing a dog jacket.

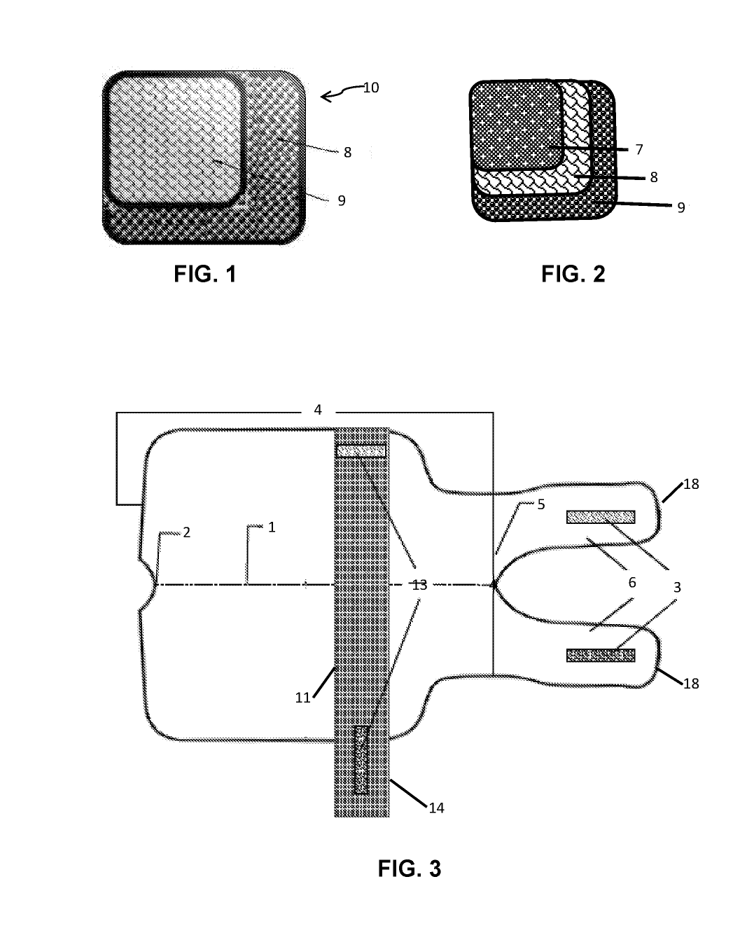

While a fabric including the temperature regulating material can be utilized as formed and as a single-layer construct in forming a dog jacket, in other embodiments, the fabric can be one layer of a multi-layer structure used in forming a jacket. By way of example, FIG. 1 illustrates one embodiment of a two-layer composite material 10 as may be utilized in forming a dog jacket. In this embodiment, a first layer 9 can be a temperature regulating layer and can include a temperature regulating material and a second layer 8 can be combined with the first layer 9 in formation of a multi-layer construct. For example, the first layer 9 can be a non-woven fabric including fibers that incorporate a temperature regulating material (e.g., Outlast Technologies® Inner Lining 7816-63 Matrix Coating Technology) and the second layer 8 can be a protective and/or decorative material, e.g., an open weave textile that can protect and/or provide a decorative outer layer to the multi-layer composite material 10.

Of course, a multi-layer construct for use in forming a dog jacket is not limited to a single or a bi-layer composite. By way of example, FIG. 3 illustrate a three-layer construct including a temperature regulating layer 9 as an inter-liner between two layers 7, 8 of e.g., light weight mesh. It should be understood that additional layers including in conjunction with a temperature regulating layer can be the same or different from one another. For instance, an outer layer (i.e., intended to be the most-exterior layer of a dog jacket during use) can be water resistant or waterproof and an inner layer (i.e., intended to be worn immediately adjacent to the dog's body) can be open weave allowing for increased air motion between the dog and the temperature regulating layer.

FIG. 3 illustrates one embodiment of a jacket according to the present disclosure that can be placed on a dog for regulating the dog's body temperature without the aid of ‘humidity’ for core proactive thermal regulation. The jacket includes a body portion 12 that can include the temperature regulating material. For instance, the temperature regulating material can be a component of a multi-layer structure, the layers of which can be attached to one another by use of a stitching line 1 that can join the various textiles to one another. The temperature regulating material can absorb energy when the dog's body temperature goes above the transition temperature and can release energy when the t surrounding temperature drops below the transition temperature thus creating a more thermally stabilized environment.

The jacket of FIG. 3 is presented in a top view and can include a stitch line 1 that passes along all or a portion of the length of the body portion 12. In one embodiment, the body portion 12 can define a tail notch 2 as shown for a more secure fit. The body portion 12 can generally extend between a collar line 5 and the backside of the jacket and have a length 4 that can vary depending upon the size of dog for which the jacket will be used. For instance, the body portion 12 can be sized to cover a majority of the dog's torso. For instance, length 4 can be about 14 inches or less for a small dog, from about 14 inches to about 18 inches for a medium-sized dog, from about 18 inches to about 20 inches for a large dog, and about 20 inches or more for a very large dog, for instance from about 20 inches to about 30 inches in some embodiments.

Similarly, the width of the body portion 12 (measured perpendicular to the length 4) can vary depending upon the size of the dog. By way of example, the body portion can be about 14 inches or less for a small dog, from about 14 inches to about 20 inches for a medium-sized dog, from about 20 inches to about 24 inches for a large dog, and about 24 inches or more for a very large dog, for instance from about 24 inches to about 32 inches in some embodiments.

The jacket can also include first and second chest flanges 6 that can extend from the body portion and during use wrap around the dog's neck and be removably attachable to one another, for instance by use of a hook and loop fastening system 3 as shown. Of course, any suitable fastening system can be incorporated in the dog jacket, and the dog jacket is not limited to hook and loop fasteners.

The flanges 6 can be extensions of the body portion (i.e., formed of the same continuous structure) or can be attached to the body portion (e.g., formed of the same or different structure as the body portion 12 and permanently or removably attached thereto). The length of the flanges 6 as measured from the collar line 5 to the end can vary depending upon the size of the dog and can be sized based on the dog's neck circumference. For instance, the flanges 6 can be about 6 inches or less (e.g., about 5.25 inches) for a small dog, from about 6 inches to about 8 inches for a medium-sized dog, from about 8 inches to about 9 inches for a large dog, and about 9 inches, e.g., from about 9 inches to about 13.25 inches for a very large dog.

The dog jacket can also include a belly band that can wrap around the dog's girth to retain the dog jacket on the dog during use. For instance, the belly band 11 can be formed of a relatively wide (e.g., about 2 inches or more) webbing to avoid rolling and an uncomfortable fit. The belly band 11 can be designed so as to allow for removably attachment around the dog's girth, for instance by use of hook and loop fastener mechanism 13 including a first component at one end of the belly band and a second component at the body portion 12 at the desired attachment point. For instance, in the illustrated example, the belly band 11 extends across the entire width of the body portion 12 and the two components of the fastener mechanism 13 are at either end of the belly band. Alternatively, one component of the fastener mechanism can be attached directly to the body portion 12. In any case, the belly band 11 can include an extension 14 that can extend from a first side of the body portion 12 and can be of a length to wrap comfortably around the dog's belly and attach to a second side of the body portion 12. For instance, and depending upon the size of the dog, the extension 14 of the belly band 11 can be from about 2 inches to about 6 inches in some embodiments.

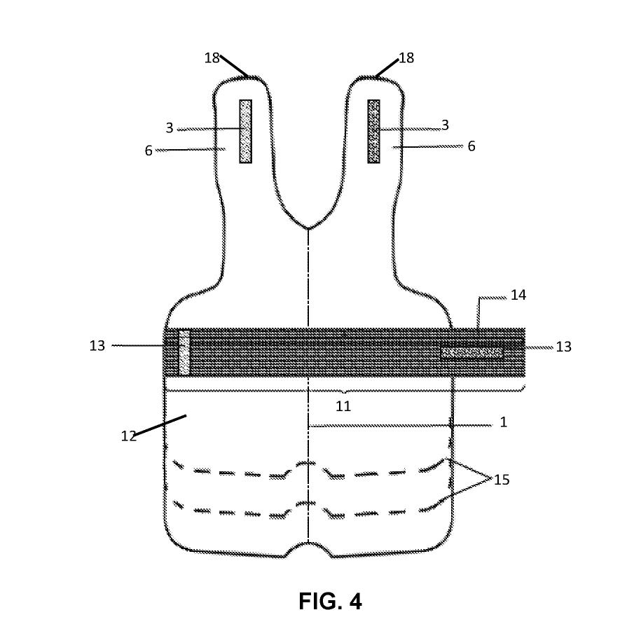

Another embodiment of a dog jacket is presented in FIG. 4. As shown, the dog jacket includes a body portion 12, flanges 6, and a belly band 11 as well as attachments 3 for the flanges 6 and attachments 13 for the belly band 11. In addition, the dog jacket includes adjustment lines 15 that can be pre-stitched lines sewn in the body portion 12. Adjustment lines 15 can be equally spaced along a length of the body portion 12 and can allow for individually sizing of the body portion by the user to personalize the fit of the dog jacket. For instance, the adjustment lines 15 can be from about 1 inch to about 3 inches apart from one another and can be formed with a relatively strong and enduring stitch or other attachment mechanism. To personalize the size of the body portion 12, a use can trim the length of the body portion along the best fit of the various adjustment lines 15. For instance, when fitting a dog with a slightly shorter torso than is comfortably fit by the as-purchased dog jacket, one or two lengths of the end of the body portion 12 can be removed by trimming along the first or second adjustment lines 15. Of course, though shown with two adjustment lines 15, a dog jacket can include fewer or more adjustment lines 15, as desired. In addition, any amount of length can be cut away during a fitting. For example, the entire distance between adjustment lines 15 can be trimmed or only a portion of that length, e.g., in ¼-inch increments, can be trimmed. As such, the dog jacket can be adjusted to fit the dog's length along the pre-formed adjustment lines 15 on body portion 12 of the jacket.

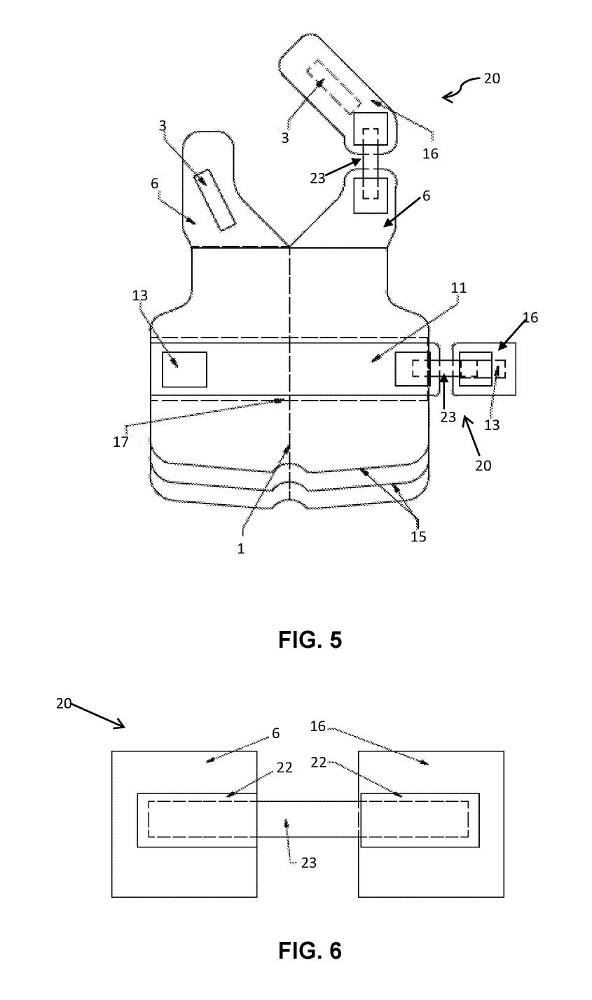

While the various components of a dog jacket can be attached to one another according to any suitable formation mechanism, in general, the various components can be stitched to one another. For example, and with reference to FIG. 4, the layers of a multi-layer body portion 12 can be stitched or otherwise attached (e.g., adhesive bonding, sonic bonding, etc.) together using a light-weight bias binding from one end of a belly band 11, across each flange 6, to the opposite side of the body portion to the second end of the belly band 11. Stitch line 1 and adjustment lines 15 can join the layers of the body portion 12 on the tail side of the body portion while allowing the out shell to lie loose over the dog's body. In addition, an attachment line, e.g., a seam can pass around the belly band 11, for instance about 0.25 inches from the edge of the belly band to attach the belly band 11 to the body portion 12. If desired, an additional seam line can be provided exterior to and surrounding the belly band 11, e.g., about 0.25 inches from the edge of the belly band 11 on one or both of the neck side and the tail side of the belly band (FIG. 5, 17).

During use, the dog jacket can be laid on the dog with the stitch line 1 generally aligned with the dog's spine and the flanges 6 attached to one another with their respective ends 18 overlapped and the flanges 6 wrapped around the dog's neck. For instance, the flanges 6 can be attached to one another such that two fingers can fit comfortably between the dog's neck and the jacket. In addition, the extension 14 of the belly band 11 can be wrapped beneath the dog's belly and the two ends of the belly band 11 attached to one another via the attachment 13. In general, the belly band 11 can be wrapped such that the jacket fit prevents loose rotation of the jacket around the dog and allows air circulation between the dog's body and the body portion.

FIG. 5 illustrates another embodiment of a dog jacket that includes an extension band 20 as a component of a flange 6 and as a connection component of a belly band 11. As can be seen with reference to FIG. 6, an extension band 20 can include an extensible length 23 that can be formed of, e.g., a non-rolling elastic that can be attached at one end as an extension of a component of a dog jacket (e.g., a flange 6 as illustrated in FIG. 6) and that can be attached at a second end to a panel 16. By way of example, the extensible length 23 can be attached via casings 22 that are attached (e.g., by stitching) to either end of the extensible length 23 and to the respective component of the dog jacket (i.e., a panel at one end and a flange portion or a belly band portion at the other). The panel 16 can include an attachment (e.g., one side of a hook and loop attachment tape) on one side by which it can be attached to a mated component. For instance, and with reference to FIG. 5, an extension band 20 can be attached as an extension of a flange 6 via an extensible length 23, as shown. During use, each flange 6 (one of which including the extension band 20) can wrap around the dog's neck and the fasteners three can be reversibly attached to one another at the underside of the dog's neck. Similarly, the belly band 11 can include an extension band 20 on one end. During use, the extension band 20 can be wrapped around the dog's girth and the mechanism 13 can be reversibly attached with the extensible band 23 pulled as necessary to a comfortable fit around the animal without excessive restriction.

While the subject matter has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present disclosure should be assessed as that of the appended claims and any equivalents thereto.

What is claimed is:

1. A dog jacket comprising:
a body portion, the body portion including a temperature regulating material;
a first chest flange extending from a collar line of the body portion;
a second chest flange extending from the collar line of the body portion, the first and second flange being removably attachable to one another; and
a belly band including a first end extending from a first side of the body portion, the first end of the belly band being removably attachable to a second side of the body portion.

2. The dog jacket of claim 1, wherein the temperature regulating material is a component of a non-woven fabric.

3. The dog jacket of claim 1, wherein the temperature regulating material is a phase change material that defines a phase transition temperature.

4. The dog jacket of claim 3, wherein the phase transition temperature is from about 22° C. to about 40° C.

5. The dog jacket of claim 3, wherein the phase transition temperature is from about 31° C. to about 34° C.

6. The dog jacket of claim 1, the body portion comprising a fiber that includes the temperature regulating material.

7. The dog jacket of claim 1, the body portion comprising a non-woven web, the non-woven web comprising fibers that include the temperature regulating material.

8. The dog jacket of claim 1, the body portion comprising a multi-layer structure, at least one layer of which including the temperature regulating material.

9. The dog jacket of claim 1, the first and second flanges and/or the first end of the belly band and the second side of the body portion being attachable to one another via a hook and loop fastener.

10. The dog jacket of claim 1, wherein the first end of the belly band is removably attachable to a second end of the belly band, the second end of the belly band being attached to the second side of the body portion.

11. The dog jacket of claim 1, the body portion including a tail notch.

12. The dog jacket of claim 1, wherein the first and second flanges are extensions of the body portion.

13. The dog jacket of claim 1, the body portion further comprising one or more adjustment lines.

14. The dog jacket of claim 1, further comprising an extension band attached as an extension of the first flange.

15. The dog jacket of claim 1, further comprising an extension band attached as an extension of the belly band.

16. A method for forming a thermally regulated dog jacket, comprising:
shaping a textile to form a body portion of the dog jacket, the textile comprising a temperature regulating material;
forming a first and second flange such that the first and second flange each extend from the body portion; and
attaching a belly band to the body portion.

17. The method of claim 16, the method further comprising attaching the textile to one or more additional layers to form a multi-layer body portion.

18. The method of claim 17, wherein the attachment of the textile to the one or more additional layers includes forming adjustment lines in the multi-layer body portion.

19. The method of claim 16, further comprising attaching an extension band to the first flange.

20. The method of claim 16, further comprising attaching an extension band to the belly band.
